(19) United States
(12) Patent Application Publication
(10) Pub. No.: US 2020/0144895 A1
(43) Pub. Date: May 7, 2020

(54) Air-Cooled Electric Motor

(71) Applicant: Franz Wölfer Elektromaschinenfabrik Osnabrück GmbH, Osnabrück (DE)

(72) Inventors: Bernd Tecklenburg, Hagen a.T.W. (DE); Nikolai Potozki, Lengerich (DE); Nils Hemker, Melle (DE)

(21) Appl. No.: 16/481,899

(22) PCT Filed: Jan. 25, 2018
(86) PCT No.: PCT/EP2018/000034

§ 371 Date: Jan. 11, 2020

(30) Foreign Application Priority Data
Jan. 31, 2017 (DE) 10 2017 000 844.2

(51) Int. Cl. H02K 9/14

(52) U.S. Cl. CPC H02K 9/14

(57) ABSTRACT

The invention relates to an air-cooled electric motor comprising a housing on which an assembly flange for receiving attachments, in particular a brake, is arranged at one end, a plurality of cooling fins which are arranged on the exterior of the housing, are distributed over the housing circumference, and run substantially parallel to a longitudinal central axis of the electric motor and over which cooling air can flow, a fan which sets the cooling air into motion and which can be driven by a fan motor, and a fan hood which conducts the cooling air in the direction of the cooling fins. The fan hood is arranged on the housing between the assembly flange and the housing end opposite the assembly flange (FIG. 1).

The invention concerns an air-cooled electric motor with a housing at which at one end an assembly flange for receiving attachments, in particular a brake, is arranged, with a plurality of cooling fins, arranged on the exterior of the housing, distributed over the housing circumference, and extending substantially parallel to a longitudinal center axis of the motor, over which cooling air can flow, as well as with a fan which sets the cooling air into motion and can be driven by a fan motor, as well as with a fan hood guiding the cooling air in the direction toward the cooling fins.

Such motors are known in the prior art. In conventional electric motors, the fan is arranged coaxial to the shaft of the electric motor at the side of the motor housing positioned opposite to the output side of the electric motor. The fan can be driven here directly by the motor shaft or motor-independently by a separate fan motor. The fan is located in a fan hood which ends flush with the axial cooling fins arranged on the housing. In operation, the fan sucks in air from the exterior. This air is guided by the fan hood to possible attachments of the motor and, past the assembly flange, to the axial cooling fins.

The installation space requirements are disadvantageous in this known solution. For example, the length of the motor with the coaxially arranged fan is significantly larger than the length of the motor housing itself. In addition, attachments which are connected by means of the assembly flange to the motor housing must be smaller in their outer circumference than at least an envelope of the axial cooling fins. The envelope in this context is described by the imagined connection of the free ends of the axial cooling fins facing away from the housing by straight lines. Ideally, the attachments are to be arranged in an installation space that is smaller than the space that is delimited by the surface defined by the base of the respective cooling fins at the circumference.

It is the object of the here presented invention to improve an air-cooled electric motor of the aforementioned kind in such a way that the installation space limitations existing in the known air-cooled motors can be handled more flexibly.

This is realized by an air-cooled electric motor according to the preamble of claim 1 in that, according to the invention, the fan hood is arranged between the assembly flange and the end of the housing positioned opposite the assembly flange. In this way, the length of the arrangement as a whole is reduced immediately. Moreover, the installation space limitations predetermined by the cooling system for the assembly flange or the attachments to be arranged at the assembly flange do not apply. In this way, it is possible to furnish motors, for example, with ultrahigh-performance and thus very voluminous brakes without impairing the effect of the air cooling of the air-cooled motor.

Preferably, the electric motor comprises in a region of the fan hood which is facing the housing at least one outlet opening for the cooling air which is facing the cooling fins. With a fan hood configured in this way flow of the cooling air toward the cooling fins in axial direction of the electric motor is achieved. The cooling air can thus flow freely over the cooling fins. By providing the outlet opening, the fan hood can also be limited only to a region of the housing which leads to a further reduction of the installation space in the direction of the longitudinal center axis for the air-cooled electric motor and thus enables a more flexible installation of the electric motor.

In an advantageous embodiment of the electric motor, the fan hood comprises an air guiding channel whose cross-sectional area is designed to decrease corresponding to the cooling air quantity that can be discharged in the direction of the cooling fins through the at least one outlet opening. In this way, it is achieved that the air quantity exiting through the outlet opening is discharged uniformly, distributed across the entire outlet region. Accordingly, a uniform and reliably supply with cooling air that is independent of the installation situation, in particular independent of the installation direction, is ensured and thus a corresponding cooling of the electric motor.

In an advantageous embodiment of the electric motor, air baffles guiding the cooling air are arranged in the fan hood. The air baffles effect a uniform distribution of the cooling air flow within the fan hood and are favorable to a uniform distribution of the cooling air onto the cooling fins in the housing. In this way, a reliable cooling of the electric motor independent of the installation situation or installation position is ensured.

Preferably, the fan hood extends about the outer circumference of the housing.

The fan hood surrounds thus the housing of the electric motor completely. In this way, the reliable supply or flow of cooling air to all cooling fins is enabled independent of the installation direction of the electric motor. Particularly preferred, the fan hood is formed of at least two fan hood parts which each comprise a housing receptacle. In this way, mounting of a fan hood surrounding the housing at the outer circumference is facilitated.

In a preferred embodiment variant of the electric motor, the fan hood is pivotable relative to the housing in circumferential direction of the housing and can be secured in different pivot positions at the housing. With this configuration of the fan hood, the motor is designed even more flexible with respect to the installation situation or the required installation space. When in a specified installation position of the electric motor, the fan hood is not possible in a position with other components, such as e.g. the fan hood of a further neighboring electric motor of the same configuration, the fan hood of the electric motor can be pivoted at the housing and can be brought into an alternative mounting position in which sufficient installation space is made available to the fan hood. Particularly preferred, the different pivot positions for securing the fan hood are arranged distributed about the entire circumference of the housing. For this purpose, the fan hood can be screwed onto the housing, for example. The screwing locations are for this purpose preferably distributed about the circumference of the housing such that the fan hood can be secured in different orientations at the electric motor. In this way, a variation of the fan position relative to the housing about 360° is possible. The individual installation positions, depending on the outer shape of the housing, can be displaced, for example, for a square basic shape, by 90°, respectively, or for a round basic shape can be adjusted in degrees or can be adjustable continuously by use of slotted holes.

In an advantageous embodiment, the housing has a cooling fin-free fan hood region. By providing a region for securing the fan hood that is free of cooling fins, the distribution of the cooling air is reliably enabled about the circumference of the housing. The reliable distribution is realized in this context independent of the installation situation of the motor or the orientation of the fan hood.

Preferably, the diameter of the assembly flange is larger than the diameter of an envelope of the cooling fins arranged on the housing. In this way, the prerequisite is provided for attaching attachments that are voluminous in comparison to the motor or to the housing of the motor.

In an advantageous embodiment, the fan hood is arranged immediately adjacent to the assembly flange. The cooling air can thus flow across the axial cooling fins arranged on the housing without being impaired by the assembly flange. In particular, the cooling air can flow completely across the housing in the direction of the output side of the electric motor. In this way, a reliable air cooling of the electric motor is achieved.

In a preferred embodiment of the electric motor, the fan is secured at the fan hood. The fan can thus be arranged in immediate neighborhood to the housing of the electric motor. Air guiding to the fan hood from the fan is not required. This leads to a more compact configuration of the electric motor.

Preferably, the fan comprises at least one protective roof at an air inlet. By arranging a protective roof at the air inlet of the fan, installation of the electric motor even in unfavorable installation situations, in which the air inlet otherwise is exposed to unfavorable environmental conditions, is enabled. For example, installation in outdoor regions is possible in which the air inlet of the fan without protective roof would be exposed immediately to the weather conditions. The protective roof increases thus the flexibility with regard to the selection of the installation situation of the electric motor.

Preferably, the electric motor comprises at the fan motor a fan motor protective roof that covers a fan motor air inlet at least partially. Since the fan motor which drives the fan is provided also frequently with its own air cooling, a protective roof above the fan motor air inlet enables a flexible installation of the air-cooled electric motor because only little consideration must be given to the installation direction and the installation situation which results for the fan motor due to the installation of the electric motor. In particular, such a fan motor protective roof enables installation of the electric motor in regions which are exposed to weather influences or other environmental influences that are unfavorable for venting without having to take into consideration the orientation of the fan motor air inlet when installing the electric motor.

Further advantages and details of the invention can be taken from the following figure description. It is shown in:

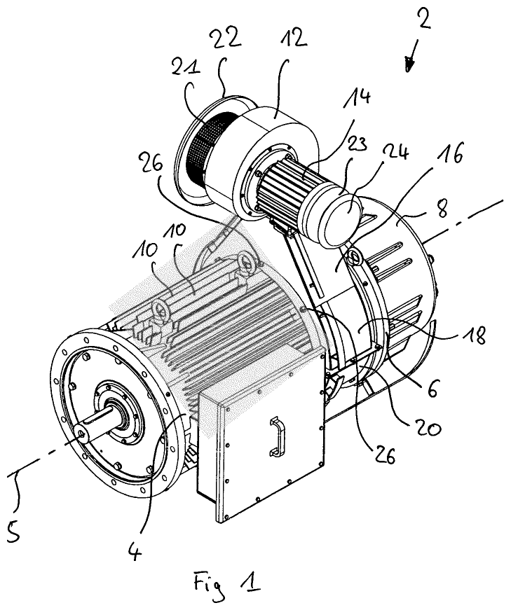

FIG. 1: an embodiment of an electric motor according to the invention with air cooling in isometric view;

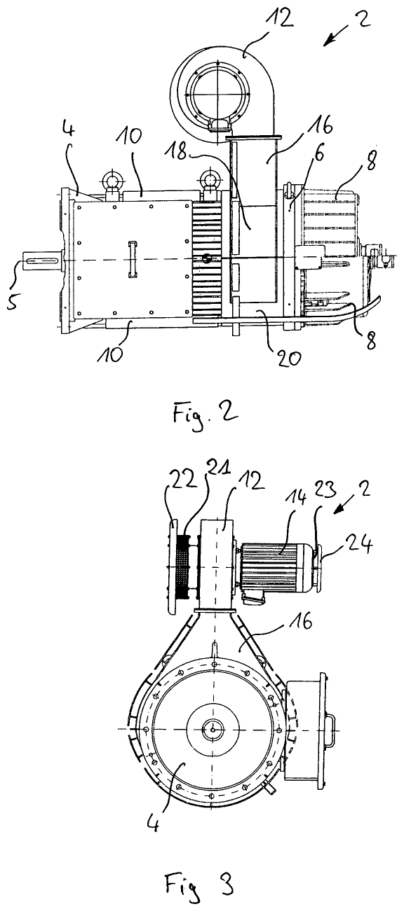

FIG. 2: the electric motor according to FIG. 1 in a side view; and

FIG. 3 the electric motor according to FIG. 1 in a view from the end face.

In the following, elements of the invention that are acting the same are provided with a uniform reference character. The features of the embodiment that are described in the following can also be subject matter of the invention in other feature combinations with the features of the independent claims.

FIG. 1 shows an electric motor 2 with a housing 4 on which cooling fins 10 are arranged parallel to a longitudinal center axis 5 of the electric motor. The electric motor 2 comprises a fan 12 which is driven by a fan motor 14.

The fan 12 is connected by a fan hood 16 to the housing 4. The housing 16 is of a two-part configuration and comprises a first housing part 18 and a second housing part 20. The housing 4 is arranged immediately adjacent to an assembly flange 6 of the housing 4 at which a brake 8 is fastened. At the air inlet 21 of the fan 12, a protective roof 22 is arranged. The latter hinders the entry of foreign bodies into the air inlet 21. At the fan motor 14 a fan motor protective roof 24 is arranged that hinders the entry of foreign bodies into the fan motor air inlet 23.

FIG. 2 shows the electric motor 2 in a side view. Above and below the longitudinal center axis 5, two different brakes 8 are illustrated which differ in regard to their size. The brakes 8 are arranged respectively at the assembly flange 6.

FIG. 3 shows the electric motor 2 in an end view. It can be seen that the housing 4 of the electric motor 2 has a substantially round basic shape. The fan hood 16 is pivotable relative to the housing 4.

The fan hood 16 can be secured via fastening locations 26 that are distributed about the circumference of the housing 4 at the latter. Due to the round basic shape of the housing 4, the fan hood 16 is continuously pivotable thereabout.

Securing can be realized respectively at the fastening locations 26. By arranging slotted holes in the fan hood 16, a further continuous pivoting of the fan hood 16 relative to the housing 4 is possible.

What is claimed is:

1.-14. (canceled)

15. An air-cooled electric motor comprising:
a motor housing;
a plurality of cooling fins arranged on an exterior of the motor and configured to have cooling airflow across, wherein the cooling fins are distributed about an outer circumference of the motor housing and extend substantially parallel to a longitudinal center axis of the electric motor;
a fan configured to set into motion the cooling air;
a fan motor operatively connected to the fan to drive the fan;
a fan hood guiding the cooling air from the fan in a direction toward the cooling fins;
an assembly flange configured to receive attachments;
wherein the fan hood is arranged at the motor housing between the assembly flange and an end of the motor housing facing the assembly flange.

16. The electric motor according to claim 15, wherein the fan hood comprises at least one outlet opening for the cooling air arranged in a region of the fan hood facing the motor housing, wherein the at least one outlet opening faces the cooling fins.

17. The electric motor according to claim 16, wherein the fan hood comprises an air guiding channel comprising a cross-sectional area configured to decrease corresponding to cooling air quantities to be discharged toward the cooling fins through the at least one outlet opening.

18. An electric motor according to claim 15, wherein the fan hood comprises air baffles arranged in an interior of the fan hood and configured to guide the cooling air.

19. The electric motor according to claim 15, wherein the fan hood extends about the outer circumference of the motor housing.

20. The electric motor according to claim 15, wherein the fan hood comprises at least two fan hood parts each comprising a housing recess.

21. The electric motor according to claim 15, wherein the fan hood is pivotable relative to the motor housing in a circumferential direction of the motor housing and is configured to be secured in different pivot positions at the motor housing.

22. The electric motor according to claim 21, wherein the different pivot positions for securing the fan hood are distributed about the entire outer circumference of the motor housing.

23. The electric motor according to claim 15, wherein the motor housing comprises a cooling fin-free fan hood attachment region.

24. The electric motor according to claim 15, wherein a diameter of the assembly flange is larger than a diameter of an envelope of the cooling fins arranged on the motor housing.

25. The electric motor according to claim 15, wherein the fan hood is arranged immediately adjacent to the assembly flange.

26. The electric motor according to claim 15, wherein the fan is secured at the fan hood.

27. The electric motor according to claim 15, wherein the fan comprises and air inlet for the cooling air and further comprises at least one protective roof covering the air inlet.

28. The electric motor according to claim 15, wherein the fan motor comprises a fan motor air inlet and further comprises a fan motor protective roof covering at least partially the fan motor air inlet.
